(19) United States
(12) Patent Application Publication
(10) Pub. No.: US 2026/0203890 A1
(43) Pub. Date: Jul. 16, 2026

(54) VEHICLE QUALITY CONTROL SYSTEM

(71) Applicant: DEGOULD LIMITED, Exeter, Devon (GB)

(72) Inventors: Daniel George GOULD, Exeter, Devon (GB); Mathew HOLLOWAY, Exeter, Devon (GB)

(21) Appl. No.: 19/136,476

(22) PCT Filed: Dec. 4, 2023
(86) PCT No.: PCT/GB2023/053120

§ 371 Date: Jun. 6, 2025

(30) Foreign Application Priority Data
Dec. 9, 2022 (GB) 2218530.0

(51) Int. Cl. G06T 7/00; B62D 65/00

(52) U.S. Cl. CPC G06T 7/001; B62D 65/005

(57) ABSTRACT

A computer implemented method of assessing the quality of a vehicle produced on a vehicle production line, the production line including a plurality of discrete vehicle production stages arranged to define a production sequence between an initial production stage and a final production stage. The method includes identifying a vehicle assembly at a first production imaging station, capturing a first set of one or more production images of the vehicle assembly following processing at a first production stage and storing the first set of production images.

The method also includes capturing one or more assessment images of the vehicle assembly following processing at the final production stage, running a defect detection algorithm to identify defects on the vehicle using the assessment images, and acquiring the production images in response to the defect detection algorithm identifying a defect on the vehicle.

### CROSS-REFERENCE TO RELATED APPLICATIONS

This application is a national stage filing of International Application No. PCT/GB2023/053120 filed on Dec. 4, 2023 (corresponding to International Publication WO 2024/121535) which in turn claims priority to GB 2218530.0 filed on Dec. 9, 2022. The entire contents of both of these applications are hereby incorporated by reference herein.

### FIELD

This disclosure relates to the field of vehicle quality control, such as quality control in a vehicle production facility.

### BACKGROUND

A vehicle production facility typically includes a production line where a vehicle is built up in discrete production stages. Production of a vehicle is initiated at a first stage and the vehicle assembly final from the first production stage passes to a subsequent production stage where the vehicle assembly is modified, for example by the addition of a further component or treatment, or the modification of an existing component. The vehicle assembly progresses through the production stages until it reaches a completion stage. There may be multiple completion stages in a production facility, for example: prior to the paint shop, when the main body is completed; when the body is fully assembled and painted; near the end of the line when the vehicle is completed and is about to undergo final testing; or, prior to leaving the factory. A typical vehicle production line can for example include 500 to 600 production stages and one to 10 completion stages.

It is known to include a quality inspection stage following a completion stage. In one example, a quality control operator has a limited period of time to visually inspect a completed vehicle to spot any defects that should be rectified before the completed vehicle leaves the production facility. In order to maintain production throughput, a quality control operator may for example have around 60 seconds to spot defects such as dents, dings, distortions, scratches, chips, paint contamination etc. and/or check whether the vehicle meets a required specification for the vehicle, where a defect can include the vehicle having an incorrect correct wheel, badge, or other feature.

If a defect is spotted, the quality control operator can enter details on the production management system and later when the vehicle reaches a repair station, technicians are directed to rectify the defect or deviation before the completed vehicle moves to the next stage of production or the vehicle leaves the production facility.

Generally, the earlier in the production line a defect is found, the cheaper it is to resolve. Should vehicles leave the production line with defects then even relatively small deviations can be vastly more expensive to fix, while the delay in spotting the defect means that the problem may go unchecked for many weeks or months resulting in many vehicles suffering the same defect before the issue is addressed.

Similarly, the journey from the production line to the first owner and dealership includes a number of logistics providers who transport the vehicle and may undertake additional work, for example fitting optional extras to the vehicle. Defects may also therefore occur along the finished vehicle logistics supply chain.

It is known to provide a camera-based imaging system at a quality control stage to quickly capture images of a completed vehicle. These images may be used to assess liability for damage or to spot defects. The images can, for example, be assessed by a remote quality control operator, by conventional computer vision algorithms, or by machine vision algorithms in order to assess whether the spec of the vehicle meets specification requirements, or a defect is present.

The present inventor(s) have recognized that known vehicle production facility quality control imaging systems can be improved.

### SUMMARY

In accordance with a first aspect, there is provided a computer implemented method of assessing the quality of a vehicle produced on a vehicle production line,

the production line comprising a plurality of discrete vehicle production stages arranged to define a production sequence between an initial production stage and a final production stage,

the method comprising:

identifying a vehicle assembly at a first production imaging station, capturing a first set of one or more production images of the vehicle assembly following processing at a first production stage and storing the first set of production images;

optionally identifying the vehicle assembly at a second production imaging station, capturing a second set of one or more production images of the vehicle assembly following processing at a second (e.g., latter) production stage distinct from the first production stage and storing the second set of production images;

identifying the vehicle assembly at an end of sequence imaging station, and capturing one or more assessment images of the vehicle assembly following processing at the final production stage;

running a defect detection algorithm to identify defects on the vehicle using the assessment images from the end of sequence imaging station; and

acquiring the production images from the first (and optionally the second) production imaging station(s) in response to the defect detection algorithm identifying a defect on the vehicle.

Thus, the quality control method according to the first aspect captures production images of a vehicle assembly between production stages. The production images can for example be images of one or more parts of the vehicle assembly as it is assembled. The production images therefore define a visual record of the vehicle being assembled i.e., the second set of production images will show the vehicle assembly in a more completed state than the first set of production images, since the vehicle assembly will have been processed by one or more production stages between capturing the first and second production images. Once the vehicle assembly has been processed at the final production stage, assessment images are captured and processed by the defect detection algorithm to identify whether defects are present on the vehicle. The end of sequence imaging station is therefore a quality control imaging stage that looks for defects such as scratches, scuffs, soils, dents, dings, chips, paint contamination, alignment or distortion issues, specification deviations and the like. If a defect is detected by the defect detection algorithm, the production images are acquired. Since the production images show the vehicle assembly at a discrete point or a plurality of discrete points along the production sequence, the presence and absence of the defect in the production images can be used to identify a production stage after which the defect first appeared, enabling the source of vehicle production line quality control problems to be quickly determined, in some cases in real time, as early as possible. As will be appreciated, the initial and final production stages can form part of a larger production process i.e., they do not need to be the absolute start and finish of the production line.

The method can comprise capturing a plurality of assessment images.

One or more, and in some embodiments all, sets of production images can each contain fewer images than the set of assessment images. One or more, and in some embodiments all, sets of production images can each contain images of lower resolution than the set of assessment images.

The method can comprise capturing additional or alternative measurements and data, other than just images, for example using a 3D laser scanner, structured light scanner, stereo vision or photogrammetry solutions to capture 2D or 3D measurements and compare these at different stages of the production process. These techniques may also be used to locate defects captured in the images on a 2D or 3D model of the vehicle in order to generate butterfly diagrams showing defect location or create heat maps over time. Therefore, the terms imaging station and image should not be considered limited to only the capture of visual information.

The method can comprise capturing one or more further sets of one or more production images of the vehicle assembly following processing at respective further distinct production stages and storing the further sets of production images. A greater number of sets of production images provides greater resolution for enabling the source of vehicle production line problems to be quickly determined. The method can comprise capturing at least two sets of production images along the production sequence and in some embodiments at least three, five, ten, 20, 50 and in some cases over 1000 sets.

The method can comprise, after the step of acquiring the production images in response to the defect detection algorithm identifying a defect on the vehicle, generating a report including at least one assessment image which shows the defect and the production images. Such a report can help a quality control operator to understand the appearance of the defect and then quickly and easily review the production images to find the production image where the defect first appears.

The method can comprise, after the step of acquiring the production images in response to the defect detection algorithm identifying a defect on the vehicle, running a defect location algorithm which searches the production images for the defect identified in the assessment images to locate the first set of production images which show the defect. The method can comprise generating a report identifying the production stage following which the defect first appears in a set of production images. Such embodiments can increase the speed of identifying the location of a defect generating production stage.

Each production image or set of production images can be tagged with the production stage at which the vehicle assembly was last processed when the images were captured. This can make it easier for a quality control operator to associate an image to a particular point in the production sequence.

The method can comprise acquiring the production images only in response to the defect detection algorithm identifying a defect on the vehicle. Such an approach can improve network efficiency since production images are only transmitted if they are needed to support a defect having been spotted.

The method can comprise deleting the production images if the defect detection algorithm does not identify a defect on the vehicle. Such an approach can reduce the need for storage, which is particularly advantageous for vehicle imaging systems due to the file size of images.

The steps of identifying the vehicle can comprise capturing and storing a vehicle assembly identifier such as a VIN along with each production image set and the assessment images.

The steps of identifying the vehicle can comprise obtaining production status information from a production line encoder/control system and/or plant management system to obtain data indicative of the vehicle assembly and/or status of the production line. The method can comprise comparing one or more defects to other data sets to identify trends, for example: whether the frequency of defect occurrence is increasing or decreasing and whether changes may be linked to other events, such as a new process being implemented; whether defects occur more or less frequently during different shifts or when certain workers are present; whether defects occur more or less frequently with certain vehicle types or vehicle specifications; or, whether defects occur more or less frequently in certain areas of the vehicle, in order to identify trends in defect location.

At least one of the production imaging stations can be movably mounted and the method can comprise in initial step of moving the production imaging station from a first location between a first pair of production stages to a second location between a second, distinct pair of production stages. Thus, production imaging stations can be capable of being repositioned as necessary to enable them to be moved for example to a production stage suspected of causing a defect.

The resulting sequence of images showing defects in different camera frames and at different stages of the production process may be used to improve the training of the defect detection algorithms. A defect may only need to be identified and confirmed once, but by using its localization data it can be identified in multiple frames and at multiple locations, automatically labelled, a bounding box created, and the data used to train machine learning models for different stages of the process.

Where the physical size of the production and delivery process means that it is not practical to run the system through a local network, a cloud storage and processing approach may be provided to create a hybrid approach. Although this means that the number of images needed to be transferred increases, the first aspect reduces long term storage costs by reducing the need for multiple images to be stored from earlier in the process which show no defects or deviations. Similarly, to enable the remote assessment of plant and delivery quality, as well as to enable different teams to assess the data, compare trends at different plants, etc., it is advantageous to store the results and end of sequence images on the cloud storage.

In accordance with a second aspect, there is provided a vehicle production facility comprising:

a vehicle production line comprising a plurality of discrete vehicle production stages arranged to define a production sequence between an initial production stage and a final production stage; and

a quality control imaging system comprising:
one or more production imaging stations located between the initial production stage and the final production stage along the production sequence, each production imaging station being located to capture a set of one or more production images of a vehicle assembly which has been processed at a production stage;
an end of sequence imaging station located to capture a set of assessment images of a vehicle assembly which has been processed at the final production stage;
an identification system arranged to identify a vehicle assembly entering each imaging station;
a first controller communicatively coupled to the end of sequence imaging station and configured to receive the assessment images captured by the end of sequence imaging station and run a defect detection algorithm to identify vehicle defects using the assessment images;
a second controller communicatively coupled to the production imaging station(s) and configured to store the production images;
a third controller communicatively coupled to the first controller and second controller and configured to acquire the production images in response to the defect detection algorithm identifying a defect on the vehicle.

The end of sequence imaging station can be modular in construction, comprising a first vehicle surface detection module, a second vehicle surface detection module and a dent/ding detection module and/or an alignment detection module. Each surface detection module can include a frame, an imaging background surface mounted on the frame, a system to illuminate the vehicle, and one or more first surface detection cameras mounted on the frame and orientated to see the imaging background surface in reflection by the vehicle assembly as it moves through the module. The imaging background surface of the first surface detection module can be relatively light or dark in comparison to the imaging background surface of the second surface detection module. In one example, the background surface of the first surface detection module can be white and illumining and the imaging background surface of the second surface detection module can be grey or black and can be a non-reflective and/or non-illuminating surface. The frames of the first surface detection module, second surface detection module and dent detection module can be provided with standardized attachment points such that each module can be quickly and easily coupled to any other of the modules, in any sequence. Each module can be provided with a module controller which serves as the first controller or one of the second controllers, so that each module is “plug and play” in nature.

Each module can be provided with an arch which extends around both sides and the top of the module to define a light-controlled vehicle assembly pathway through the module. When two or more modules are attached together, the respective covers join to form a continuous, light-controlled vehicle assembly pathway through the imaging station. Such embodiments enable light to be controlled for imaging the sides and top of a vehicle assembly.

Where for example just one side of a vehicle assembly is required to be imaged by a particular production imaging station, the production imaging station can include a partial arch. The partial arch can extend for just a half, a third, or a quarter of a full arch as defined by the surface and dent detection modules of the end of sequence imaging station. In such embodiments, the partial arch module can be provided with a cover which extends around both sides and the top of the module to define a light-controlled vehicle assembly pathway through the module.

Each production imaging station can include one or two modules present in the end of sequence imaging station. Thus, the production imaging stations can be smaller in terms of mechanical footprint/size and/or simpler than the end of sequence imaging station, which can reduce the overall size and cost of the quality control system.

Each module can be arranged to be movably positioned. Thus, it can be straight forward to move modules of the imaging station from one point in the production line to another point, such that the production imaging arrangement can be changed as desired to move a production imaging station to a location where a fault is expected. Data on the trends for defects may identify locations in the plant and on the vehicle where these faults occur. This information can then be used to move imaging stations to an area of interest in the plant. By identifying the area on the vehicle that a problem occurs, the need for a full arch is eliminated and a local camera and lighting solution can be easily installed to look at a specific area of a vehicle, e.g., the lower door sill.

The first controller can be coupled to the end of sequence imaging station by a wired connection. In use, the end of sequence imaging station can quickly capture hundreds or thousands of high-resolution images of the vehicle assembly to be processed by the defect detection algorithm. Thus, data heavy transfer can be carried out without utilising wireless network bandwidth of the vehicle production facility.

Optional features of the first aspect can be applied to the second aspect in an analogous manner.

In accordance with a third aspect, there is provided a quality control imaging system for use in the vehicle production facility of the second aspect, comprising:

one or more production imaging stations each arranged to be located between the initial production stage and the final production stage along the production sequence, each production imaging station being located to capture a set of one or more production images of a vehicle assembly which has been processed at a production stage;

an end of sequence imaging station arranged to be located to capture a set of assessment images of a vehicle assembly which has been processed at the final production stage;

an identification system arranged to identify a vehicle assembly entering each imaging station;

a first controller communicatively coupled to the end of sequence imaging station and configured to receive the assessment images captured by the end of sequence imaging station and run a defect detection algorithm to identify vehicle defects using the assessment images;

a second controller communicatively coupled to the production imaging station(s) and configured to store the production images;

a third controller communicatively coupled to the first controller and second controller and configured to acquire the production images in response to the defect detection algorithm identifying a defect on the vehicle.

Optional features of the first and second aspects can be applied to the third aspect in an analogous manner.

In accordance with a fourth aspect, there is provided a computer implemented method of assessing the quality of a vehicle as the vehicle passes a plurality of discrete vehicle journey stages between an initial production stage and a final delivery stage, the method comprising:

identifying a vehicle assembly at a first journey imaging station, capturing a first set of one or more journey images of the vehicle following processing at a first operation stage and storing the first set of journey images;

optionally identifying the vehicle assembly at a second journey imaging station, capturing a second set of one or more journey images of the vehicle following processing at a second journey stage distinct from the first journey stage and storing the second set of journey images;

identifying the vehicle at an end of sequence imaging station, and capturing one or more assessment images of the vehicle following processing at a final journey stage;

running a defect detection algorithm to identify defects on the vehicle using the assessment images; and

acquiring the journey images in response to the defect detection algorithm identifying a defect on the vehicle.

Thus, an inventive concept of the first aspect can be applied more broadly in vehicle production and delivery process, wherein journey stages can comprise production stages, delivery stages or a mixture of both. Likewise for the second and third aspects in an analogous fashion. In both stages the process may include a mixture of operations to assemble the vehicle, address deviations to the spec, repair defects or inspect the vehicle; the finished vehicle logistics chain has similar processes to the production plant, they are just distributed. Similarly, the disclosure has the advantage that defects only need to be identified at the end of sequence, but once they are identified the previous images can be checked for damage manually by the operator or using damage detection algorithms. This avoids the unnecessary processing of large datasets and in the case of finished vehicle logistics means that vehicles mid journey, which may be soiled or dirty, do not need to be checked unless damage is found at the final inspection stage.

Optional features of the first to third aspects can be applied to the fourth aspect in an analogous manner.

The end of sequence imaging station can comprise, for example, a mobile device (e.g., phone, tablet or similar) and an application to allow an operator to mark damage manually on the image of the vehicle. This can enable defects to be identified on soiled or dirty vehicles which might otherwise create a large number of false detections when using a defect detection algorithm.

Any aspect can comprise multiple end of sequence imaging stations positioned at quality gates in the production and delivery process, for example: at the end of the body shop to check the chassis before it is e-coated; after the paint shop to check for paint and surface defects; to check for defects and deviations from the required specification where components such as doors are pre-assembled; to check for defects and deviations from the required specification in the finished vehicle at end of the production line; at key handover points in the delivery and logistics journey; and/or at handover to the dealer at the end of the journey.

Defect detection algorithms may be used to identifying a defect at any end of sequence station. In practise this is determined by whether there is a repair or rework station and the need to identify defects in real time so they can be repaired before leaving this stage. In addition, due to the time taken for a vehicle to pass through the entire production and delivery journey, where a trend is identified it may be desirable to run the defect detection algorithms at additional imaging stations to create a greater fidelity and shorter time period between detection points.

Therefore, it may be desirable that imaging stations can be easily configured to run defect detection algorithms as an end of sequence station or to act as a slave and simply record the condition of the vehicle using images, physical measurements and other sensor inputs. Therefore, it is advantageous if the hardware is flexible and can be set as slave or master.

In any embodiment, the system can be configured to detect a defect in a 2D image of a vehicle, output a 3D location of the defect detected in the image and uses the 3D location of the defect to identify a panel and optionally a zone in the panel that the defect is on and reproject the 3D locations onto a plurality of 2D diagrams of the views of the vehicle from different viewing angles.

In accordance with further aspects, there are provided a system and method for detecting a defect in a 2D image of a vehicle, outputting a 3D location of the defect detected in the image and using the 3D location of the defect to identify a panel and optionally a zone in the panel that the defect is on and reproject the 3D locations onto a plurality of 2D diagrams of the views of the vehicle from different viewing angles. The process can be repeated for multiple defects to generate heat maps in the 3D and 2D representations.

### BRIEF DESCRIPTION OF THE DRAWINGS

By way of example only, certain embodiments will now be described by reference to the accompanying drawings, in which:

FIG. 1 is a diagram of a vehicle production facility;

FIG. 2 is a diagram of a vehicle production facility according to an embodiment;

FIG. 3 is a diagram illustrating an example of a vehicle identification arrangement;

FIG. 4 is a diagram of a modular imaging station that can be used as the end of sequence imaging station in a vehicle production facility according to an embodiment;

FIG. 5 is a diagram of a subset of the modules of the modular imaging station of FIG. 4;

FIG. 6 is a flow chart illustrating a computer implemented quality control method according to an embodiment;

FIG. 7 is diagram illustrating AI training and deployment phases for an imaging system according to an embodiment;

FIG. 8 is a diagram of a vehicle quality control imaging system according to an embodiment, distributed across production and delivery sites; and

FIG. 9 is a diagram showing defect heat maps on 3D and 2D visualization of a vehicle.

### DETAILED DESCRIPTION

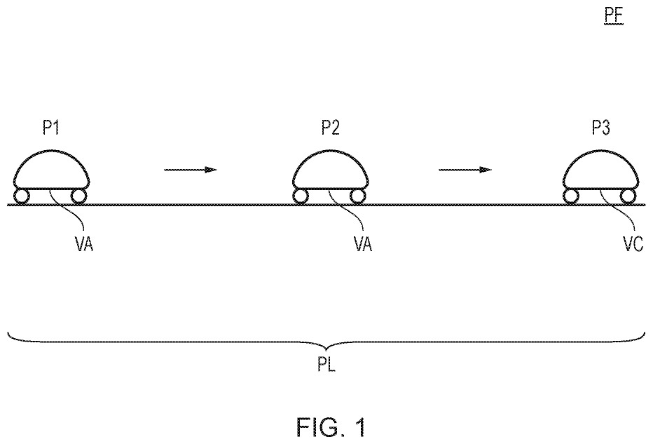

FIG. 1 shows a vehicle production facility PF. The production facility can for example be configured to produce cars, vans, motorbikes, or the like.

The vehicle production facility PF includes a vehicle production line PL comprising a plurality of discrete vehicle production stages P1, P2, P3 arranged to define a production sequence between an initial production stage P1 and a final production stage P3. It will however be appreciated that for ease of illustration only a small number of productions stages are shown, whilst in practice the vehicle production facility PF may have any number of production stages, such as 100 or more, 200 or more, 300 or more, 400 or more and in some cases between 500 and 600 production stages. Moreover, although the production sequence is shown as being linear, the sequence can include multiple component strands where components such as doors are assembled in a linear path and these paths feed in parallel into the overall vehicle production line PL.

In this embodiment the initial production stage P1 is arranged to carry out a first process which defines a vehicle assembly VA. The final production stage P3 is arranged to carry out a final process which results in a completed vehicle VC. One or more intermediate stages P2 are arranged to carry out respective processes to the vehicle assembly VA to develop the vehicle assembly VA towards becoming a completed vehicle VC.

It will however be appreciated that the initial production stage P1 can for example receive a partially assembled vehicle and the final production stage P3 can output an incomplete vehicle, such that the production sequence forms part of a greater production sequence. Moreover, while the production sequence is shown as being within a single production facility PF, the sequence can be split between multiple production facilities and can include a finished vehicle logistics journey, where the final production stage P3 is a delivery stage.

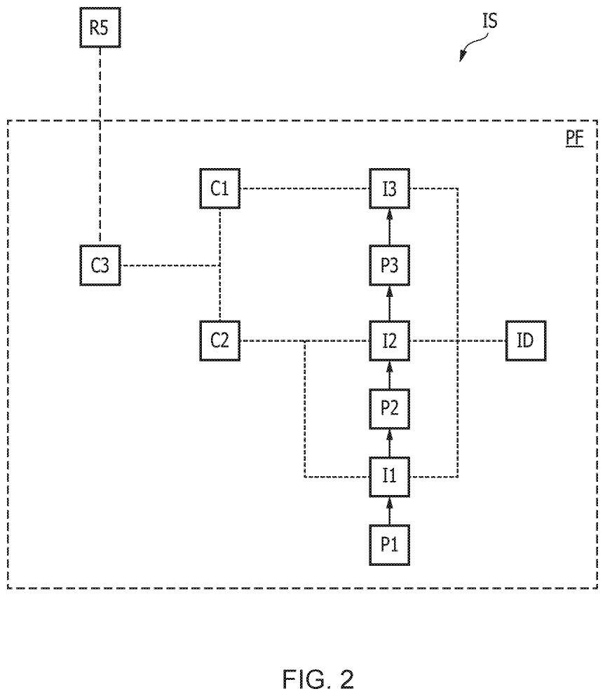

Referring additionally to FIG. 2, in addition to a conventional vehicle production line PL, the vehicle production facility PF includes a quality control imaging system IS according to an embodiment.

The quality control imaging system includes a plurality of production imaging stations I1, I2 located between the initial production stage P1 and the final production stage P3. Each production imaging station I1, I2 is located to capture one or more production images of a vehicle assembly which has been processed at a production stage. In the illustrated embodiment, the first production imaging station I1 is located between the first production stage P1 and the second production stage P2 so that, as the vehicle assembly arrives at the first production imaging system I1, the vehicle assembly has been processed at the first production stage P1 but has not yet been processed at the second production stage P2. Likewise, the second production imaging station I2 is located between the second production stage P2 and the third production stage P3. Embodiments can be provided with any number of production imaging stations, such as one, or more than two.

As such, each production imaging station I1, I2 is arranged to capture images of the vehicle assembly VA following processing at the previous production stage but before processing occurs at the next production stage.

In other embodiments, one or more of the production imaging stations can, where appropriate, be collocated with the preceding production stage, assuming the vehicle assembly VA is visible for imaging. Moreover, while two production imaging stations are shown, in other embodiments the quality control imaging system can include any number of production imaging stations and in some embodiments one of more of the production imaging stations can be hand operated cameras, where a user knows their location when taking the production image set and manually transmits the images and identifier to the second controller though a software application.

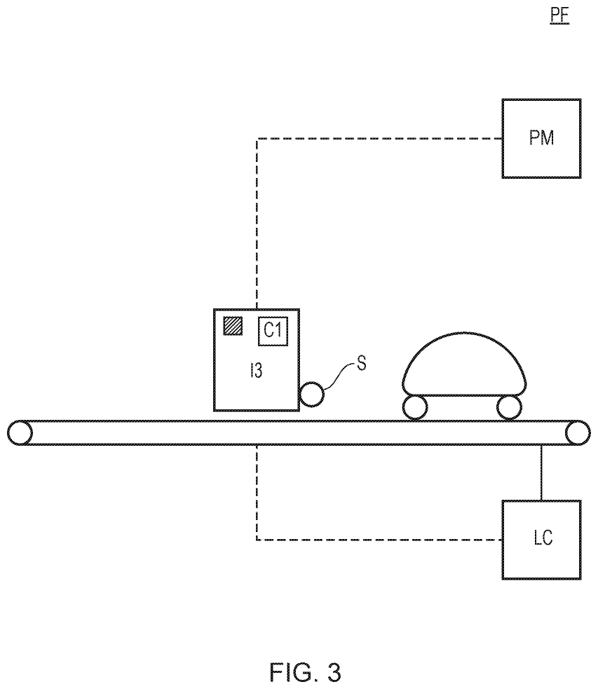

The quality control imaging system also includes an end of sequence imaging station I3 located to capture a plurality of assessment images of a vehicle assembly which has been processed at the final production stage P3. The end of sequence imaging station I3 can be a vehicle imaging system such as that described with reference to FIG. 3 of WO2021/064351A1, having scratch detecting cameras arranged to view light and dark imaging background surfaces in reflection via the vehicle, and dent detecting cameras arranged to view a structured light image projected by a structure light source. As such, the end of sequence imaging station I3 is a relatively complex imaging station in comparison to requirements for some or all production imaging stations.

As will be appreciated, each imaging station can include one or more digital cameras and image acquisition software configured to capture one or more digital images of one or more portions of the vehicle assembly. A plurality of the imaging station may be able to see the same parts of the vehicle assembly as it progresses, so that if a defect is identified by the end of sequence imaging station, the part will also be visible in a plurality of sets of production images. The greater the number of imaging stations which can see the same part, the greater the resolution of the system for fault finding should a defect occur in relation to the part. In one example, each imaging station forms an arch around the production line so that all external surfaces of the vehicle assembly are imaged. However, in some embodiments, certain production imaging stations can be arranged to focus on, for example, one side of the vehicle assembly.

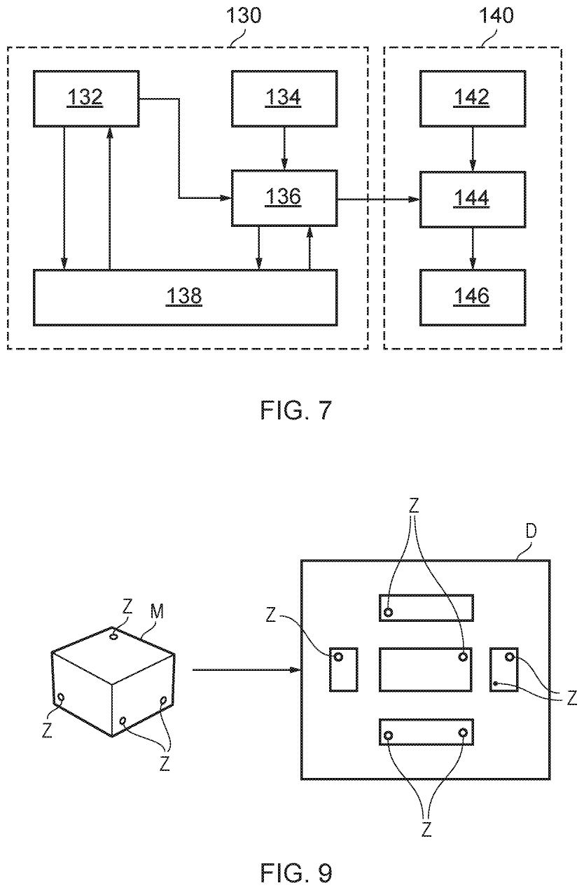

A first controller C1 is communicatively coupled to the end of sequence imaging station I3 over a data network and configured to receive the assessment images captured by the end of sequence imaging station I3 and execute a defect detection algorithm to identify vehicle defects using the assessment images. The defect detection algorithm is explained in more detail with reference to FIG. 7 below.

The first controller C1 can be coupled to the end of sequence imaging station by a wired data connection. Thus, data heavy transfers can be carried out without utilising wireless network bandwidth of the vehicle production facility PF.

A second controller C2 is communicatively coupled to the production imaging stations I1, I2 and configured to store the production images of the vehicle assembly.

A third controller C3 is communicatively coupled to the first controller C1 and second controller C2 and configured to acquire the production images from the second controller C1 in response to the defect detection algorithm identifying a defect on the vehicle assembly.

Thus, the quality control imaging system captures production images of a vehicle assembly between production stages. The production images can for example be images of one or more parts of the vehicle assembly as it is assembled. The production images therefore define a visual record of the vehicle being assembled i.e., the second set of production images will show the vehicle assembly in a more completed state than the first set of production images, since the vehicle assembly will have been processed by one or more production stages between capturing the first and second production images. Once the vehicle assembly has been processed at the final production stage, assessment images are captured and processed by the defect detection algorithm to identify whether defects are present on the vehicle. The end of sequence imaging station is therefore a quality control imaging stage that looks for defects such as scratches, dents, dings, alignment issues and the like. If a defect is detected by the defect detection algorithm, the production images are acquired. Since the production images show the vehicle assembly at a plurality of discrete points along the production sequence, the presence and absence of the defect in the production images can be used to identify a production stage after which the defect first appeared, enabling the source of vehicle production line quality control problems to be quickly determined.

The functions of the three controllers are shown independently for ease of understanding, but it should be noted that each function can be implemented by a single controller, or a distributed computing system as may be desired. In the illustrated embodiment the second controller is shown as a single controller that is coupled to each of the production imaging stations, but the second controller can be distributed; for example, each production imaging station can include a second controller.

The data network linking the controllers to the imaging stations can for example comprise an industrial protocol network such as Modbus or OPC or can comprise a high-speed data communication standard connection such as USB, IEEE 802 or IEEE 1394.

Each controller can be implemented as dedicated computer system having a computer processor and non-transitory computer readable memory for storing computer instructions for performing the functions described herein. At least the first controller C1 can comprise one or more digital signal processors (DSP) for analysing large amounts of digital image data.

The third controller C3 can be communicatively coupled to a remote server RS via a wired or wireless data connection, at which a user can view a document generated by the third controller C3. Such a document can for example include an assessment image illustrating a defect and the productions images. The remote server can run a dashboard for reporting defect trends and analytics.

In some embodiments, at least some of the controllers can be located remote from the production facility PF; for example, the first and third controllers C1, C3 can be remote from the production facility. Thus, images can be processed locally (e.g., edge computing) via computer in the production facility, or can be process remotely via cloud processing for example.

The quality control imaging system IS also includes a vehicle identification system ID arranged to identify a vehicle assembly entering each imaging station. As illustrated in FIG. 3, the imaging system IS can be coupled to the production line control system LC and production line management system PM to obtain information identifying a vehicle assembly approaching each imaging station. For example, a sensor S such as a light beam or video feed can detect when the vehicle assembly VA is at an imaging station, the imaging system requests the vehicle assembly identification from the production line control system LC and then request additional information such as vehicle type, component identifiers and the like. The identification system ID can alternatively or in addition comprise a camera located at each imaging station and positioned to read a vehicle identification number VIN on the vehicle assembly. As such, the quality control imaging system can track a vehicle assembly as it passes through the system.

Knowing the vehicle assembly and the location and orientation of the imaging stations relative to the production line, the system can know which components of the vehicle assembly are visible to each camera or other information gathering device of the imaging system IS and this information can be associated with images and measurements captured at each imaging station.

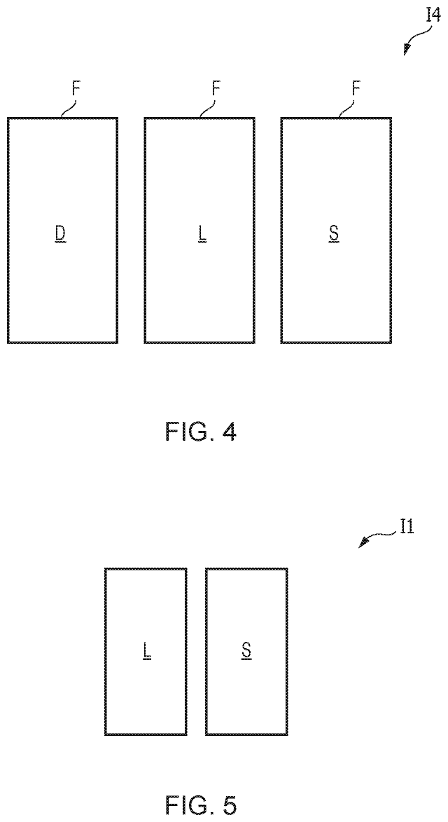

Referring additionally to FIG. 4, the end of sequence imaging station I4 can be modular in construction, comprising a first scratch detection module D, a second scratch detection module L and a dent detection module S. Each scratch detection module can include a frame F, an imaging background surface mounted on the frame F and one or more first scratch detection cameras mounted on the frame and orientated to see the imaging background surface in reflection by the vehicle assembly as it moves through the module. The imaging background surface of the first scratch detection module can be relatively light or dark in comparison to the imaging background surface of the second scratch detection module. In one example, the background surface of the first scratch detection module can be white and illumining and the imaging background surface of the second scratch detection module can be grey or black and can be a non-reflective and/or non-illuminating surface. The dent detection module S can include a frame F, a structured light source mounted on the frame and arranged to generate a structured light image, and one or more dent detection cameras mounted on the frame and orientated to see the structured light image on the vehicle assembly as it moves through the module. An alignment module (not shown) can also be provided for “gap and flush” testing.

The frames F of the first scratch detection module, second scratch detection module and dent detection module can be provided with standardized attachment points such that each module can be quickly and easily coupled to any other of the modules, in any sequence. In one example, the frames can be provided with attachment holes that coaxially align when two modules are placed end to end. The frames can for example be laser cut metal to improve coupling accuracy between modules.

Each module can be provided with a module controller which, in addition to controlling components of the module such as cameras and light sources, serves as, or forms part of, the first controller C1, or serves as one of the second controllers C2, so that each module D, L, S is “plug and play” in nature. A modular system can be beneficial in terms of ease of installation, planning and interoperability.

Each module can be provided with an arch which extends around both sides and the top of the module to define a light-controlled vehicle assembly pathway through the module. When two or more modules are attached together, the respective covers join to form a continuous, light-controlled vehicle assembly pathway through the imaging station. Such embodiments enable light to be controlled for imaging the sides and top of a vehicle assembly.

In any embodiment the cameras can comprise scan cameras such as one or more Hikvision (RTM) MV-CA050-10GC area scan cameras.

Referring additionally to FIG. 5, some or all of the production imaging stations I1-I3 can each include one or two modules present in the end of sequence imaging station I4. Thus, the production imaging stations I1-I3 can be smaller in terms of mechanical footprint/size and/or simpler than the end of sequence imaging station, which can reduce the overall size and cost of the quality control imaging system while providing high resolution detection of a production stage causing defects. In this example, production imaging stations I1 includes modules L and S.

Each module can be arranged to be movably positioned. Thus, it can be straight forward to move modules of the imaging station from one point in the production line to another point, such that the production imaging arrangement can be changed as desired to move a production imaging station to a location where a fault is expected.

In some embodiments, the quality control imaging station IS can include a controller configured to receive the production images and execute a defect location algorithm to identify a production imaging station at which the defect is first visible. This could for example be performed by the first controller C1. The defect location algorithm can be trained and deployed in the same manner as the defect detection algorithm.

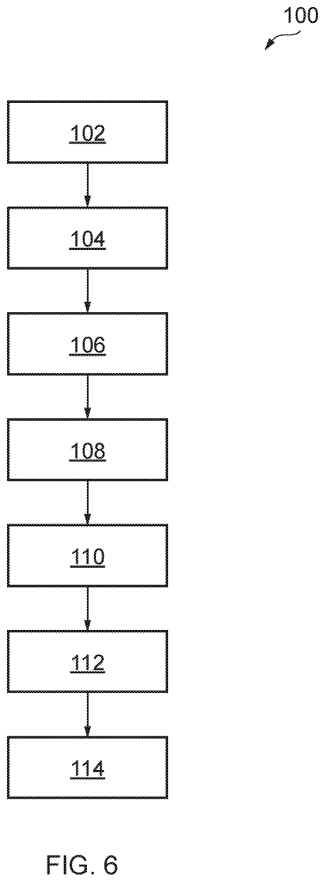

Referring additionally to FIG. 6, a computer implemented method of assessing the quality of a vehicle produced on a vehicle production line is shown generally at 100. The production line comprises a plurality of discrete vehicle production stages arranged to define a production sequence between an initial production stage and a final production stage.

At step 102, the method comprises identifying a vehicle assembly at a first production imaging station, capturing a first set of one or more production images of the vehicle assembly following processing at a first production stage and storing the first set of production images.

At step 104, the method comprises identifying the vehicle assembly at a second production imaging station, capturing a second set of one or more production images of the vehicle assembly following processing at a second production stage distinct from the first production stage and storing the second set of production images.

At step 106, the method comprises identifying the vehicle assembly at an end of sequence imaging station and capturing one or more assessment images of the vehicle assembly following processing at the final production stage.

At step 108, the method comprises running a defect detection algorithm to identify defects on the vehicle using the assessment images from the end of sequence imaging station.

At step 110, the method comprises acquiring the production images from the first and second production imaging stations in response to the defect detection algorithm identifying a defect on the vehicle. The production images can be acquired only if the defect detection algorithm identifies a defect.

At step 112, the method comprises an optional step of generating a report including at least one assessment image which shows the defect and the production images.

At step 114, the method comprises an optional step of deleting production images of the vehicle assembly if the defect detection algorithm does not identify a defect on the vehicle assembly.

The method can include an optional step of repositioning one or more of the production imaging stations prior to step 102.

Referring now to FIG. 7, a system diagram is shown illustrating the AI training phase 130 and deployment phase 140 for systems according to embodiments.

The training phase 130 comprises a data and pre-processing module 132, an AI algorithm module 134, a training algorithm module 136 and an underlying architecture/platform on which the training phase 130 is carried out.

At the data and pre-processing module 132, training images of damaged vehicles are provided to illustrate what the system will be seeking to identify and quantify. For example, images which have visible and labelled scratches and/or dents are provided. For each type of damage, the severity can be labelled such that the AI can infer both a type of damage and its severity. The images may have a resolution such that one millimeter on a vehicle corresponds to approximately 3 or 4 pixels on the corresponding image of the vehicle. In one example implementation, this resolution is achieved using 64 megapixel images. The training data also includes labelling information corresponding to regions of the vehicles where an instance of damage is located. A labelled region associated with an image can correspond to a bounding box defining a region of the image containing damage. As such, the labelling information comprises, for a given image, a bounding box (e.g., relative x-y location of the top left corner of the region along with a width and/or height of the region) and a label corresponding to the class of damage contained within the region (e.g., scratch, dent, chip, etc.). Each image within the training data can be associated with more than one labelled region. In one example implementation, the training data comprises 500 manually annotated images of damaged vehicles, where each image contains one or more labelled regions associated with either a scratch class, dent class, or chip class.

The AI algorithm module 134 can comprise a known algorithm such as a convolution neural network (CNN), support vector machine (SVM) or the like.

The training algorithm module 136 applies the training data 132 to the AI algorithm 143. If the AI algorithm is CNN based or the like then the training algorithm can comprise back propagation with stochastic gradient decent. If the AI algorithm is SVM based then the training algorithm can comprise the use of known methods such as quadratic programming.

The AI training platform can comprise any suitable conventional computing device, for example comprising one or more GPUs, and can be implemented as a distributed network of commuting devices.

The deployment phase 140 forms an integral part of the vehicle imaging station 1 and comprises a new data module 142, a model module 144 and a predictions module 146.

The model module 144 comprise the trained algorithm that was output from the training algorithm module 136 and is executed on the data processor 42, but can alternatively be executed by a data processor on a server for example.

The model module 144 receives as inputs the damage assessment images from new data module 142. Thus, the trained model is a program executable to identify vehicle defects using the captured images.

The model module 144 outputs predictions 146 comprising one or more of: instances and types of damage; severity of the damage; and location(s) of the damage.

In one example, a defect multi-task CNN assess the vehicle condition using machine learning datasets to provide a probability of damage, damage class and damage size. The multi-task CNN can operate locally on a data processor associated with the imaging station and/or in cloud-based computing, such as on the server. The multi-task CNN can continue to expand and learn using the images captured in the system. In one example, the trained neural network can be augmented using new data. Alternatively, the model can be updated by retraining the entire model, in some cases using the already trained model as a starting point i.e. rather than starting with a completely random configuration of network weights, the pre-trained weights are used as a starting point.

In one specific example implementation, AI algorithm module 134 implements a YOLO algorithm trained on a data set such as that described above in relation to the data and pre-processing module 132. The YOLO algorithm comprises a CSPDarknet53 backbone and a YOLOv5 object detector. The architecture is a convolutional base layer with a cross stage partial block which splits the feature map in the base layer and merges. The hyperparameters for the YOLO algorithm were determined using a standard grid search approach and the algorithm was trained using an Adam optimizer with a ε=1e⁻⁷, β₁−0.9, and β₁−0.999.

Images can be uploaded into cloud storage, where they can be retrieved by the client from any location worldwide. Once all images are uploaded, they can be distributed to the AI via worker queues, which ensure services running the AI are processing the images in the order they are uploaded. The AI works directly on images of the vehicle. The machine learning models can be comprised of convolutional neural networks with YOLO object detection architecture and imagenet backbone are trained on hundreds of thousands of examples of previous vehicle defects, such that they are able to “learn” what constitutes a defect and what does not. The AI models can be deployed onto powerful cloud servers with cutting-edge GPU compute processing, which process the images and return detections as coordinate-based bounding boxes for display in a front-end dashboard.

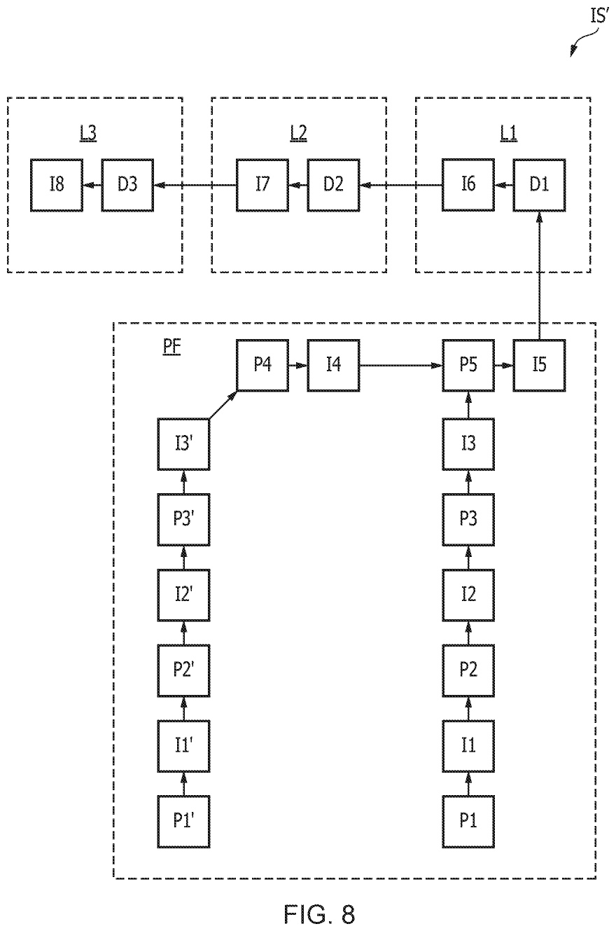

FIG. 8 is a diagram of a vehicle quality control imaging system IS′ according to an embodiment distributed across production and delivery sites. The imaging system IS′ is similar to the imaging system IS described above and for brevity following description will focus on the differences.

In this embodiment, the production facility PF includes a first strand of production stations P1′-P3′ and a second strand of production stations P1-P3 which feed into a common production line of stations P4, P5. The first strand can assemble a first component such as a door and the second strand can assemble a difference component such as a bonnet. Imaging stations I1′-I3′, I1-I5 are provided between production stations as described above. In this example, imaging stations I1′, I2′ can be production imaging stations for recording images of the component being assembled on the first strand and I3′ can be an end of sequence imaging station for quality control of the first component. A repair station (not shown) can be located between imaging station I3′ and the next production station P4. Likewise, imaging stations I1, I2 can be production imaging stations for recording images of the component being assembled on the second strand and I3 can be an end of sequence imaging station for quality control of the second component. A repair station (not shown) can be located between imaging station I3 and the next production station P5. Multiple further production strands can be provided with imaging stations located as desired. The common or “main” production line is also provided with production imaging stations such as I4 and end of sequence imaging stations such as I5. As such, quality control imaging can be carried out at various stages of the production process.

The system IS′ in this embodiment also includes an imaging station I6 for a first delivery stage D1 at a first delivery location L1. The first delivery stage can for example be a location outside of the factory where vehicles are stored before being loaded onto a ship for overseas transportation. Likewise, the system includes an imaging station I7 for a second delivery stage D2 at a second delivery location L2. The second delivery stage can for example be a location where vehicles are stored after being unloaded from a ship. Likewise, the system includes an imaging station I8 for a third delivery stage D3 at a third delivery location L3. The third delivery stage can for example be dealership. Imaging stations I6 and I7 can be production imaging stations and the imaging station I8 can be an end of sequence imaging station.

The end of sequence imaging station I8 can comprise a mobile device (e.g., phone, tablet or similar) and an application to allow an operator to mark damage manually on the image of the vehicle. This can enable defects to be identified on soiled or dirty vehicles which might otherwise create a large number of false detections when using a defect detection algorithm.

Thus, an inventive concept can be applied more broadly in a vehicle production and delivery process, wherein journey stages can comprise production stages, delivery stages or a mixture of both.

Referring additionally to FIG. 9, in any embodiment, the end of sequence imaging station can be configured to identify which component of a vehicle a defect is on and also its location on the component from the assessment images. A dedicated controller can be provided for this purpose. In one example, a localization module of the system converts the pixel coordinates of defects found in assessment images into 3D positions (x, y, z) in the reference frame of the vehicle and assigns attributes such as predefined panel and zone names. A calibration module can be comprised by an intrinsics calibration module, an extrinsics calibration module and a depth map generation module. The calibration phase is conducted once per system and vehicle model and is used to identify the parameters of the cameras and create an offline 3D representation of the vehicle at the camera triggering positions as the vehicle enters the system. The intrinsics calibration module calculates the intrinsic parameters of the cameras such as the focal length, the optical centres and the distortion coefficients. The extrinsics calibration module calculates the position and orientation of the cameras relative to the system reference frame for example by using key points selected as ground truth on an exact replica of the vehicle in a 3D simulation environment and the same key points selected as seen on the images captured from the system. The depth map generation module uses the intrinsics and extrinsics parameters and generates depth maps that have the 3D location of each point of the 3D model of the vehicle for each camera in the system and for each possible position of the vehicle inside the scanning area. In the deployment phase the ray casting module then loads all information generated during the calibration phase and outputs the 3D location of the defects that were detected on images. The module places the 3D model of the vehicle in the estimated position based on the camera triggering and casts a ray going from the cameras through the pixel coordinates of the image and into the 3D space and returns the location information of the defects from the depth maps. The system can create a 3D visualization M of the vehicle showing the defect. The 3D visualization M can be rotated by a user, for example a user viewing the visualization at the remote server RS. A panel identification module then uses the 3D location of the defects to identify the panel and zone in the panel that the defect is on. The module can reproject the 3D locations onto 2D diagrams D of the views of the vehicle from different viewing angles (e.g. left, right, front, rear, top) based on the size of the vehicle. This process can be repeated for multiple vehicles to create heat maps of defects and locations which occur over a period of time. The heat maps can include zones Z in the 3D representation M and 2D diagrams D indicating the number and locations defects visually by colour, size etc. The defect localization algorithm can be used to indicate locations where the system estimates the defects to have occurred. Embodiments therefore extend to systems and methods which detect a defect in a 2D image of a vehicle, output a 3D location of the defect detected in the image and uses the 3D location of the defects to identify a panel and optionally a zone in the panel that the defect is on and reproject the 3D locations onto a plurality of 2D diagrams of the views of the vehicle from different viewing angles. Such embodiments do not require any production imaging stations or the second and third controllers i.e. the systems and methods can simply use images of a vehicle at a single location such as an end of sequence imaging station.

Although embodiment and aspects of the invention have been described above with reference to one or more embodiments, it will be appreciated that various changes or modifications can be made without departing from the scope of the invention as defined in the appended claims. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage.

What is claimed is:

1. A computer implemented method of assessing quality of a vehicle produced on a vehicle production line, the production line comprising a plurality of discrete vehicle production stages arranged to define a production sequence between an initial production stage and a final production stage, the method comprising:
identifying a vehicle assembly at a first production imaging station, capturing a first set of one or more production images of the vehicle assembly following processing at a first production stage and storing the first set of production images;
identifying the vehicle assembly at an end of sequence imaging station, and capturing one or more assessment images of the vehicle assembly following processing at the final production stage;
running a defect detection algorithm to identify defects on the vehicle using the assessment images; and
acquiring the production images in response to the defect detection algorithm identifying a defect on the vehicle.

2. The method of claim 1, further comprising identifying the vehicle assembly and capturing one or more further sets of one or more production images of the vehicle assembly following processing at respective further distinct production stages and storing the further sets of production images.

3. The method of claim 1, wherein one or more of the sets of production images each contains fewer images than the set of assessment images and/or contains images of lower resolution than the set of assessment images.

4. The method of claim 1, further comprising, after the step of acquiring the production images in response to the defect detection algorithm identifying a defect on the vehicle, generating a report including at least one assessment image which shows the defect and the production images.

5. The method of claim 1, further comprising, after the step of acquiring the production images in response to the defect detection algorithm identifying a defect on the vehicle, running a defect location algorithm which searches the production images for the defect identified in the assessment images to locate the first set of production images which shows the defect and generating a report identifying the production stage following which the defect first appears in a set of production images.

6. The method of claim 1, further comprising associating each production image set with the production stage at which the vehicle assembly was last processed when the images were captured.

7. The method of claim 1, further comprising deleting the production images if the defect detection algorithm does not identify a defect on the vehicle.

8. The method of claim 1, whereby the steps of identifying the vehicle comprise capturing and storing a vehicle assembly identifier with each production image set and the assessment image set.

9. The method of claim 1, further comprising an initial step of moving a production imaging station from a first location between a first pair of production stages to a second location between a second, distinct pair of production stages.

10. A vehicle production facility comprising:
a vehicle production line comprising a plurality of discrete vehicle production stages arranged to define a production sequence between an initial production stage and a final production stage; and
a quality control imaging system comprising:
one or more production imaging stations located between the initial production stage and the final production stage along the production sequence, each production imaging station being located to capture a set of one or more production images of a vehicle assembly which has been processed at a production stage;
an end of sequence imaging station located to capture a set of a plurality of assessment images of a vehicle assembly which has been processed at the final production stage;
an identification system arranged to identify a vehicle assembly entering each imaging station;
a first controller communicatively coupled to the end of sequence imaging station and configured to receive the assessment images captured by the end of sequence imaging station and run a defect detection algorithm to identify vehicle defects using the assessment images;
a second controller communicatively coupled to the production imaging station(s) and configured to store the production images; and
a third controller communicatively coupled to the first controller and second controller and configured to acquire the production images in response to the defect detection algorithm identifying a defect on the vehicle.

11. The vehicle production facility of claim 10, wherein the end of sequence imaging station is modular in construction, comprising a first surface defect detection module, a second surface defect detection module and a dent detection module, wherein each surface detection module includes a frame, an imaging background surface mounted on the frame and one or more first surface detection cameras mounted on the frame and orientated to see the imaging background surface in reflection by the vehicle assembly as it moves through the module, wherein the imaging background surface of the first surface detection module is relatively light or dark in comparison to the imaging background surface of the second surface detection module, wherein the dent detection module includes a frame, a structured light source mounted on the frame and arranged to generate a structured light image, and one or more dent detection cameras mounted on the frame and orientated to see the structured light image on the vehicle assembly as it moves through the module.

12. The vehicle production facility of claim 11, wherein the frames of the first surface detection module, second surface detection module and dent detection module are provided with standardized attachment points, such that each module can be quickly and easily coupled to any other of the modules, in any sequence and/or each module is provided with a module controller configured to serve as the first controller or one of the second controllers.

13. The vehicle production facility of claim 11, wherein each module is provided with an arch which extends around both sides and the top of the module to define a light-controlled vehicle assembly pathway through the module.

14. The vehicle production facility of claim 11, wherein one or more of the production imaging stations each includes one or two modules present in the end of sequence imaging station and each module is arranged to be movably positioned relative to the production line.

15. The vehicle production facility of claim 10, wherein the first controller is coupled to the end of sequence imaging station by a wired connection.

16. A quality control imaging system for use in the vehicle production facility of claim 10, comprising:
one or more production imaging stations each arranged to be located between the initial production stage and the final production stage along the production sequence, each production imaging station being located to capture a set of one or more production images of a vehicle assembly which has been processed at a production stage;
an end of sequence imaging station arranged to be located to capture a set of assessment images of a vehicle assembly which has been processed at the final production stage;
an identification system arranged to identify a vehicle assembly entering each imaging station;
a first controller communicatively coupled to the end of sequence imaging station and configured to receive the assessment images captured by the end of sequence imaging station and run a defect detection algorithm to identify vehicle defects using the assessment images;
a second controller communicatively coupled to the production imaging station(s) and configured to store the production images; and
a third controller communicatively coupled to the first controller and second controller and configured to acquire the production images in response to the defect detection algorithm identifying a defect on the vehicle.

17. A computer implemented method of assessing quality of a vehicle as the vehicle passes a plurality of discrete vehicle journey stages between an initial stage and a final stage, the method comprising:
identifying a vehicle assembly at a first journey imaging station, capturing a first set of one or more journey images of the vehicle following processing at a first operation stage and storing the first set of journey images;
identifying the vehicle at an end of sequence imaging station, and capturing one or more assessment images of the vehicle following processing at a final journey stage;
running a defect detection algorithm to identify defects on the vehicle using the assessment images; and
acquiring the journey images in response to the defect detection algorithm identifying a defect on the vehicle.
